(19) United States
(12) Patent Application Publication
(10) Pub. No.: US 2012/0238295 A1
(43) Pub. Date: Sep. 20, 2012

(54) METHOD AND APPARATUS FOR RECOMMENDING CONTENT BASED ON CONTENT PROVISION MODELS ASSOCIATED WITH SPATIAL REGIONS

(75) Inventor: Sailesh Sathish, Tampere (FI)

(73) Assignee: Nokia Corporation

(21) Appl. No.: 13/047,283

(22) Filed: Mar. 14, 2011

(51) Int. Cl. H04W 4/02

(52) U.S. Cl. 455/456.3

(57) ABSTRACT

An apparatus may include a content module configured to provide for recommendation of one or more content segments based at least in part on a recipient region. A registrar may be configured to provide for access to a plurality of content provision models configured to recommend the content segments, wherein the content provision models correspond to a plurality of spatial regions. Further, a locator module may be configured to determine a recipient region of the spatial regions at which one or more of the content segments are to be provided. Thereby a user may be provided content based on a content provision model of a service provider associated with the location of the user. A manager entity may coordinate registration of service providers and user terminals and/or facilitate transfer between the content provision models of the service providers when the user transfers between spatial regions.

### TECHNOLOGICAL FIELD

An example embodiment of the present invention relates generally to techniques for recommending content and, more particularly, relates to an apparatus, a method and a computer program product for recommending content based on content provision models associated with spatial regions.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels may utilize mobile terminals to communicate with other individuals or contacts, receive services and/or share information, media and other content.

Some of the technologies which are becoming more popular are those of location based services and other personalized services. In this regard, some technologies may provide users of properly equipped mobile terminals with content that is specific to the present location of the user. Thus, for example, the user may be provided with weather information relating to the user's present location. Thereby, content may be provided to the user which may be relevant to the user's interests and current context. However, it may still be possible to improve the provision of content to users.

### BRIEF SUMMARY

A method, apparatus and computer program product are therefore provided that may recommend content based on content provision models associated with spatial regions.

In an example embodiment, an apparatus comprises at least one processor and at least one memory including computer program code, the at least one memory and the computer program code configured to, with the processor, cause the apparatus to provide access to a plurality of content provision models configured to recommend one or more content segments, wherein the content provision models correspond to a plurality of spatial regions. Further, the apparatus may determine a recipient region of the spatial regions at which one or more of the content segments are to be provided. Additionally, the apparatus may provide for recommendation of one or more of the content segments based at least in part on the recipient region.

In an additional example embodiment a method comprises providing access to a plurality of content provision models configured to recommend one or more content segments, wherein the content provision models correspond to a plurality of spatial regions. The method may also include determining a recipient region via a processor of the spatial regions at which one or more of the content segments are to be provided. Further, the method may include providing for recommendation of one or more of the content segments based at least in part on the recipient region.

In a further example embodiment a computer program product comprises at least one computer-readable storage medium having computer-executable program code portions stored therein, the computer-executable program code portions comprising program code instructions providing for access to a plurality of content provision models configured to recommend one or more content segments, wherein the content provision models correspond to a plurality of spatial regions. The computer program produce may further comprise program code instructions for determining a recipient region of the spatial regions at which one or more of the content segments are to be provided. Also, the computer program product may include program code instructions providing for recommendation of one or more of the content segments based at least in part on the recipient region.

In a further example embodiment an apparatus comprises means for providing access to a plurality of content provision models configured to recommend one or more content segments, wherein the content provision models correspond to a plurality of spatial regions. The apparatus may also include means for determining a recipient region of the spatial regions at which one or more of the content segments are to be provided. Additionally, the apparatus may include means providing for recommendation of one or more of the content segments based at least in part on the recipient region.

In some embodiments transfer between the content provision models may be provided based on a change in the recipient region. Further, a user decision to accept or reject one or more service conditions associated with transfer between the content provision models may be provided. Also, a home region may be registered. Additionally, the content provision models may be associated with a plurality of access information. The content provision models may be further configured to provide for recommendation of the content segment based on a user profile. Access to each of the content provision models may be provided with a common account.

User interface circuitry may also be provided which is configured to facilitate user control of at least some functions through use of a display. The user interface circuitry may cause at least a portion of a user interface to be displayed on the display to facilitate user control of at least some functions. Accordingly, embodiments of the present invention may provide a way to recommend content based on content provision models associated with spatial regions. Thus, for example, service providers may provide content based on respective content provision models associated with spatial regions.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to recommend content based on content provision models associated with spatial regions according to an example embodiment of the present invention;

FIG. 3 illustrates a schematic block diagram of an embodiment of the apparatus of FIG. 2 including additional components configured to recommend content based on content provision models associated with spatial regions according to an example embodiment of the present invention; and

FIG. 4 illustrates a flowchart of the operations performed in recommending content based on content provision models associated with spatial regions according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a computer-readable storage medium, which refers to a non-transitory, physical storage medium (e.g., volatile or non-volatile memory device), can be differentiated from a computer-readable transmission medium, which refers to an electromagnetic signal.

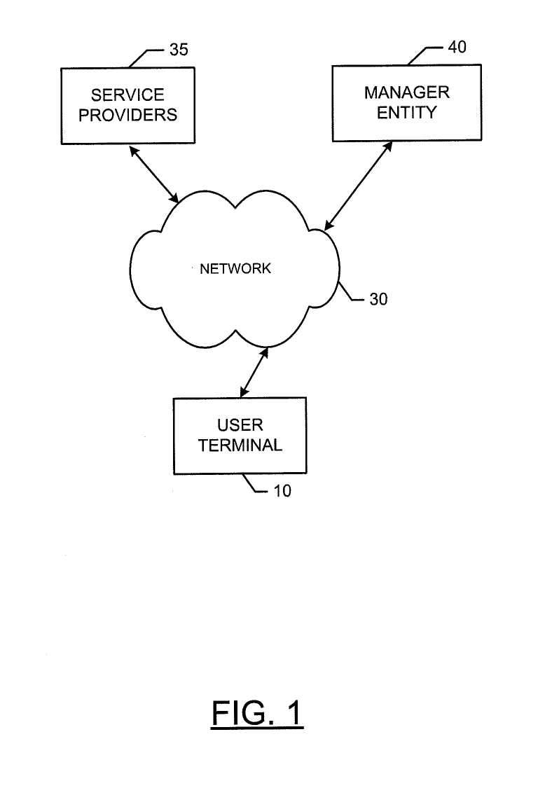

As indicated above, some embodiments of the present invention may be employed in methods, apparatuses and computer program products configured to recommend content based on content provision models associated with spatial regions. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a user terminal 10. The user terminal 10 may be any of multiple types of fixed or mobile communication and/or computing devices such as, for example, personal digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G); 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The user terminal 10 may be configured to request, receive, and output Uniform Resource Locators (URLs), text, pictures, data, audio, video, and/or various other embodiments and media formats of content segments. In some embodiments the content may be recommended for, and/or provided to, the user terminal 10 by one or more of a plurality of service providers 35 that may employ respective content provision models to select the content segments. One or more of the service providers 35 may be embodied as a server, server bank or other computer or other computing device or node configured to recommend and provide content segments to the user terminal 10. Each of the service providers 35 may have any number of functions or associations with various services. As such, for example, one or more of the service providers 35 may be a platform such as a dedicated server (or server bank), or one or more of the service providers may be a backend server associated with one or more other functions or services. Thus, the service providers 35 may employ respective content provision models to recommend and/or provide content to the user terminal 10 for use by a user thereof. Accordingly, the service providers 35 may embody a content provider and/or a content recommender in some embodiments.

In some embodiments the service providers 35 may be configured to recommend and/or provide content to the user terminal 10 only within the bounds of respective spatial regions. For example, each of the service providers 35 may have a spatial region associated therewith. By way of further example, each of the service providers may have a mutually exclusive spatial region associated therewith. Thereby, each of the service providers 35 may be configured to recommend and/or provide content to the user terminal 10 only when the user terminal is located within the respective spatial regions. In some embodiments each service provider 35 may have its own business model and content provision models associated therewith. For example, one service provider 35 may provide advertisements along with recommendations, whereas other service providers might charge for the content recommendation service while another service provider may charge data providers for recommending their content.

In some embodiments the system may further comprise a manager entity 40. The manager entity 40 may be configured to coordinate the provision and/or recommendation of the content segments by the service providers 35. For example, the manager entity 40 may register user terminals 10 and/or service providers 35 and/or provide for transfer between the various content provision models of the service providers 35 based on a change in the recipient region (e.g. the spatial region in which the user terminal is positioned). The manager entity 40 may be embodied as a server, server bank or other computer or other computing device or node configured to coordinate the provision and/or recommendation of the content segments by the various service providers 35, as discussed above. The manager entity 40 may have any number of functions or associations with various services. As such, for example, the manager entity 40 may be a platform such as a dedicated server (or server bank), or one or more of the service providers may be a backend server associated with one or more other functions or services.

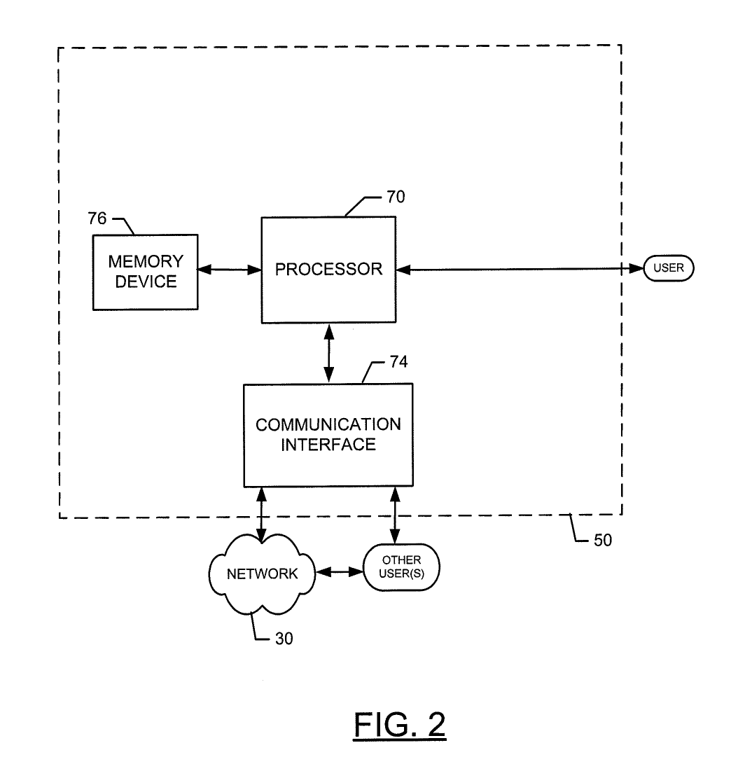

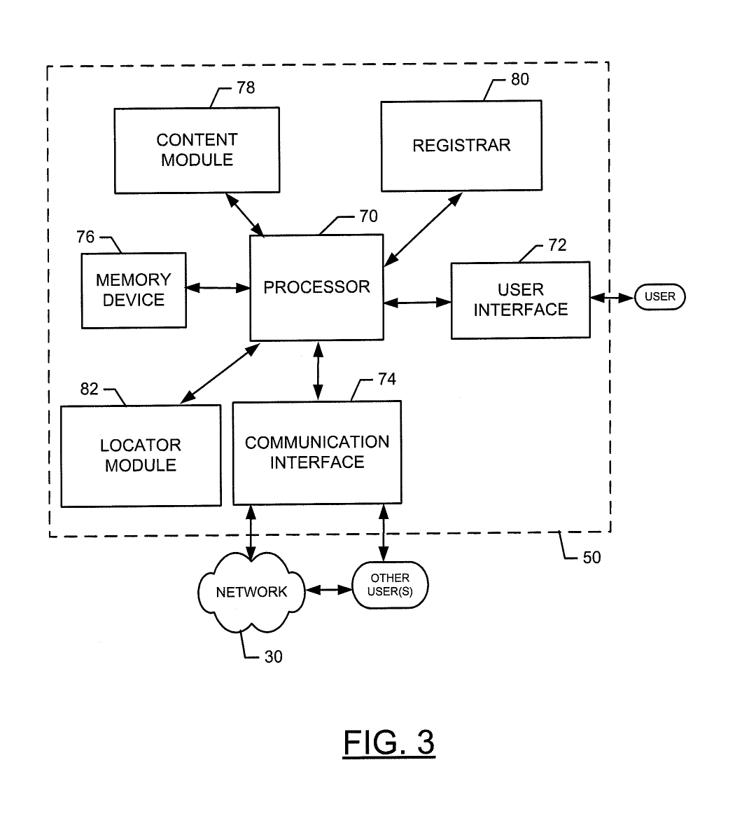

In example embodiments illustrated in FIGS. 2 and 3, an apparatus 50 is provided that may be employed by devices performing example embodiments of the present invention. The apparatus 50 may be embodied, for example, as any device hosting, including, controlling, comprising, or otherwise forming a portion of the user terminal 10, the service providers 35, and/or the manager entity 40. However, embodiments may also be embodied on a plurality of other devices such as for example where instances of the apparatus 50 may be embodied on the network 30. As such, embodiments of the apparatus 50 illustrated in FIGS. 2 and 3 are merely examples and may include more, or in some cases, less than the components shown in FIGS. 2 and 3.

With further regard to FIGS. 2 and 3, the apparatus 50 may be configured to provide for recommendation of content based on content provision models associated with spatial regions by itself forming the recommendation or, conversely, receiving the embodiment depending on whether the apparatus is embodied as the manager entity 40 or the user terminal 10, for example. As depicted in FIG. 2, the apparatus 50 may include or otherwise be in communication with a processor 70, a communication interface 74, and a memory device 76. The memory device 76 may include non-transitory and tangible memory that may be, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

As mentioned above, the apparatus 50 may, in some embodiments, be a user terminal or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a user terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

The communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

As mentioned above, embodiments of the apparatus 50 may include more, or in some cases less, than the components shown in FIG. 2. In this regard, FIG. 3 illustrates an embodiment of the apparatus 50 comprising additional components configured to provide for recommendation of content based on content provision models associated with spatial regions. The apparatus 50 may include or otherwise be in communication with the processor 70, the communication interface 74, and the memory device 76 as described above with respect to FIG. 2. Note that a module, as may be used herein, need not necessarily be modularized, but instead may be distributed in some embodiments. Thus, the term module is only used to designate the functions associated with or performed by the respective module, rather than any structure associated therewith.

In some embodiments the apparatus 50 may further comprise a user interface 72. The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor 70 may be configured to control one or more functions of one or more elements of the user interface 72 through computer program instructions (for example, software and/or firmware) stored on a memory accessible to the processor 70 (for example, memory device 76, and/or the like).

In some embodiments the apparatus 50 may comprise a content module 78, a registrar 80, and/or a locator module 82. The specific functions of the content module 78, the registrar 80, and the locator module 82 may vary depending on the particular embodiment of the apparatus 50, as will be discussed below. However, in general terms, the content module 78 may be configured to provide for recommendation of one or more content segments based at least in part on the recipient region. The registrar 80 may be configured to provide for access to a plurality of content provision models configured to recommend the content segments, wherein the content provision models correspond to a plurality of spatial regions. Further, the locator module 82 may be configured to determine a recipient region of the spatial regions at which one or more of the content segments are to be provided.

As noted above, in some embodiments the apparatus 50 may comprise a content module 78 that may be configured to provide for recommendation of one or more content segments. The processor 70 may be embodied as, include or otherwise control the content module 78. In embodiments in which the apparatus 50 is embodied as or otherwise associated with the user terminal 10, the content module 78 may be configured to provide for recommendation of one or more content segments by issuing a request for content. In one embodiment the request for content may comprise a Hypertext Transmission Protocol (HTTP) GET request. The request for content may include location and/or other contextual information relating the user terminal 10, user profile information, user preference information, and/or other information in some embodiments. The content module 78 may direct an initial content request to a default URL (or other default access information). The default URL may be associated with the manager entity 40 in some embodiments.

Conversely, in embodiments in which the apparatus 50 is embodied as, or otherwise associated with the manager entity 40, the content module 78 may be configured to provide for recommendation of one or more content segments by receiving the request for content and processing the request as may be appropriate. In this regard, the content module 78 of the manager entity 40 may itself be configured to recommend one or more content segments. However, if the request is received from a user terminal 10 in a recipient region for which a service provider 35 has licensed the spatial region, the content module 78 may direct the request for content (and/or future requests for content) to that service provider such that the request for content may be processed based on a content provision model associated therewith. Accordingly, the content module 78 may select the appropriate service provider 35 for providing the content, and/or the content module may itself provide content.

As noted above, in some embodiments the apparatus 50 may comprise a registrar 80 that may be configured to provide for access to content provision models configured to recommend the content segments, wherein the content provision models correspond to spatial regions. The processor 70 may be embodied as, include or otherwise control the registrar 80. In embodiments in which the apparatus 50 is embodied as or otherwise associated with the manager entity 40, the registrar 80 may be configured to provide for access to the content provision models by registering the service providers 35. In this regard, the registrar 80 may be configured to license spatial regions to each of the service providers 35, as mentioned above.

For example, each service provider 35 may be licensed a mutually exclusive spatial region such that for each spatial region only one of the service providers may provide content to the user terminals 10 located therein. Accordingly, the registrar 80 may validate (e.g., by registering and/or checking operation of) a plurality of information relating to the service providers 35. For example, the registrar 80 may validate a license key, access information associated with the service provider 35 (such as a uniform resource locator (URL), as will be described below), and the spatial region for each service provider. Accordingly, the registrar 80 may associate each of the service providers 35 (and thereby the content provision models relating thereto) with a plurality of access information.

The registrar 80 may also be configured to provide for registration of the user terminals 10 with the service providers 35 in embodiments in which the registrar is embodied as or otherwise associated with, the manager entity 40. In this regard, as discussed above, the user terminal 10 may initially send a request for content to the manager entity 40. The registrar 80 may thus respond with a registration package including the access information relating to the one of the service providers 35 that is selected, as discussed above. For example, the registration package may in one example embodiment appear as follows in extensible markup language (XML) form:

<XML wrapper>
Re-direct URL: www.redirecturl.com (example redirect URL)
Service-provider: Provider Name (or other identifier)
Spatial Region: Spatial Region name (or other identifier)
Coordinate: latitude, longitude (central coordinate for service deployment)
Range: range of service (radius expressed in meters/kilometers)
Guest login: yes/no (are guests allowed to use the service?)
Service Account URL: URL to create user account (or other access
information)
Account Mapping: specifications regarding availability of usage of a
common account for usage of the service provider (e.g., NOA
(Nokia Accounts), OpenID, etc.)
</XML Wrapper>

As illustrated, the registration package may include the access information for receiving content from a service provider 35 associated with the recipient region of the user terminal 10. The access information may include a “redirect” URL configured to direct future requests for content to the service provider 35 after the registrar 80 provides the user terminal with the access information. As further illustrated, in some embodiments the spatial regions may be defined by a set of central coordinates and a radius around which the spatial region extends. However, the spatial regions may be shaped differently in other embodiments and/or defined by other information. The spatial regions may also overlap to a certain degree that would be managed by the service provider 35. Thus, although the spatial regions are generally described herein as being mutually exclusive, the spatial regions need not necessarily be mutually exclusive in all embodiments, and the description regarding mutual exclusivity is provided for example purposes only.

As further noted above, the registration package may specify whether a guest login is allowed. Logging in as a guest may mean that the user terminal 10 can request content without login credentials and thereby a generic profile may be used by the service providers 35 for recommendation of content segments. In some embodiments, the user terminal 10 may provide profile or preference information along with the content request when logging in as a guest. Further, a Service Account URL may specify a URL (or other access information) that may be used to create a new user account with the service provider 35 instead of logging in as a guest. Additionally, account mapping may provide for access to each of the content provision models of the service providers 35 with a common account. In this regard, for example, the service provider 35 may accept logins through Nokia Accounts, OpenID accounts, and/or other accounts. Accordingly, creation of a new user account may not be required for each of the service providers 35 in some embodiments.

Conversely, in embodiments in which the apparatus 50 is embodied as or otherwise associated with the user terminal 10, the registrar 80 may be configured to provide for access to the content provision models configured to recommend the content segments by registering the user terminal with one or more service providers 35. In this regard, the registrar 80 may provide for storage of the information described above which is included in the registration package. For example, the registrar 80 may create an account bank that includes registration information. Further, the registrar 80 may issue an HTTP PUT message, though various other embodiments of registration messages may be issued in other embodiments. The HTTP PUT message may be issued to register a home region for the user terminal 10 by sending the registration message to the service provider 35 associated with the home region. Determination of the home region may be conducted by, or in conjunction with, the locator module 82, as will be discussed below.

In one embodiment the registration message may include a name of the user, a phone number associated with the user terminal 10, and/or a single sign on token if supported by the service provider 35. However, in other embodiments the registration message may include more or less information. The registration message may be issued to the redirect URL in some embodiments. The registrar 80 may also function to deregister from a service provider 35 when the home region changes. Note that when there is no home region, the content module 78 of the user terminal 10 may send the request for content to the manager entity 40, a nearest server to the current location of the user terminal associated with a service provider 35, or a service provider that was previously associated with the user terminal's home region. The user may be allowed to select one of these options in some embodiments.

In a further embodiment, the registrar 80 and/or other portions of the apparatus 50 may be embodied as or otherwise associated with the service providers 35. In this regard, when the service providers 35 receive an initial request for content from a user terminal 10, the registrar may be configured to register the information received in the GET request. Further, the registrar 80 may be configured to respond with authentication details if required and a model transition (or initiation) package that may include service conditions specifying the business model, payment modes, etc. The transition package may be processed by the registrar 80 of the user terminal 10 and/or a separate transaction engine and/or payment module. The transition package may in some embodiments be provided in XML form by the service providers 35 to the user terminal 10 as follows:

<modelTransition>
<modelType> one of enumerated business model type: paymentMode,
advertisementMode, providerRecommendationMode</modelType>
<modelDescription>Brief description of model type
employed</modelDescription>
<paymentMode>Optional: payment modes accepted by the service
provider</paymentMode>
<operatorBillingMode>supported/not supported (user terminal can choose
payments to go through network operator, if
supported)</operatorBillingMode>
<rewardsSystem>Optional and if applicable</rewardsSystem>
</modelTransition>

Thereby, the registrar 82 of the user terminal 10 (or a separate transaction engine) may process the transition package and inform the user about the prevailing business model. The user may be informed through any intuitive manner such as a pop-up message via the user interface. In some embodiments the registrar 80 may provide for a user decision to accept or reject the service conditions associated with transfer between the content provision models of the service providers 35 (or initial use of a content provision model). The registrar 80 of the user terminal 10 may send the user decision to the service provider 35 in the form of a new PUT request in some embodiments. Where payments for using the service are needed, the registrar 80 (and/or a separate payment module) may be used to process payment, or the user may be billed through a cell service provider (or other entity) associated with the user terminal 10.

As noted above, in some embodiments the apparatus 50 may comprise a locator module 82 that may be configured to determine a recipient region of the spatial regions at which one or more of the content segments are to be provided. The processor 70 may be embodied as, include or otherwise control the locator module 82. In embodiments in which the apparatus 50 is embodied as or otherwise associated with the user terminal 10, the locator module 82 may be configured to determine a location of the user terminal 10. For example, the locator module 82 may comprise or otherwise be associated with a GPS module. However, the locator module 82 may additionally or alternatively determine the location of the user terminal 10 by other means, such as through triangulation with cell towers, etc. Conversely, when the locator module 82 is embodied on the manager entity 40, the locator module may be configured to determine which of the spatial regions corresponds to the location of the user terminal 10. In some embodiments, the user may manually provide the location (e.g., in low cost devices where automated location determination is not available) or select a location via a map interface. Thereby, the locator module 82 may determine a home region for the user terminal 10. For example, the locator module 82 may consult registration information collected by the registrar 80 regarding the service providers 35 to determine the home region, and the registrar may register the home region for the user terminal 10.

However, in other embodiments the functions of the locator module 82 may vary. For example, in one embodiment the locator module 82 may additionally or alternatively be embodied on or otherwise associated with the service providers 35. In this regard, a locator module 82 embodied on a service provider 35 may be configured to receive location information from the user terminal 10 included with the GET request for content and determine whether the location of the user terminal is within the spatial region of the service provider. If the location is within the spatial region, the service provider 35 may provide content to the user terminal 10 according to the service provider's content provision model.

However, if the locator module 82 determines that the location of the user terminal 10 is outside of the service provider's spatial region, the service provider 35 may respond with a redirect message, which may or may not also include content segment recommendations based on the content provision model. The redirect message may redirect the user terminal 10 to the manager entity 40 for the next content request, or the redirect message may redirect the next content request to the service provider 35 corresponding to the present location of the user terminal 10. In this regard, in some embodiments the service providers 35 may be configured to access the registry information collected by the manager entity 40 regarding the service providers.

In an alternate embodiment, a locator module 82 embodied on the user terminal 10 may be configured to access the registry information collected by the manager entity 40 regarding the service providers 35. Thereby, the user terminal 10 may itself automatically redirect to the correct service provider based on the recipient region corresponding to the location of the user terminal. Accordingly, regardless of the particular implementation thereof, in some embodiments the locator module 82 and/or the registrar 80 may provide for transfer between the content provision models of the service providers 35 based on a change in a recipient region at which the user terminal 10 is located.

Returning to the content module 78, as noted above, in some embodiments the content module may be configured to provide for recommendation of one or more content segments based at least in part on the recipient region. In embodiments in which the apparatus 50 is embodied as, or otherwise associated with the user terminal 10, the content module 78 may be configured to provide for recommendation of the content segments by providing the service providers 35 with additional information useable to recommend content segments, such as context information relating to the user and/or the user terminal. Further, the content segments that are recommended under the content provision models of the service providers 35 may be based on a user profile and/or user preference information relating to the user terminal 10 and/or the user thereof. In some embodiments recommendations of content segments may be token-based and resolved through a rule set and/or collaborative recommendations may be employed.

Additionally, for service providers 35 that employ user accounts, a learnt profile may be used to recommend content in addition to user context information provided by the user terminal 10. However, when the user terminal 10 logs in as a guest (e.g., without a user account or password), the content module 78 (or a separate preference manager) of the user terminal 10 may build a package that includes current user profile information and/or user preference information. In this regard, the user profile/preference information may be included with the above-described GET request, and the package may include the following information in some embodiments: user gender, country of stay, country of origin, age, language preferences (multiple languages in order of preference), etc. In other embodiments, as discussed below, the service providers 35 may be provided with a URL or other access information for accessing user profile/preference information.

The content module 78 may in one embodiment maintain a user profile vector in the user terminal 10 that may be built and learnt from user interactions with applications and data on the device. The user profile vector may include numbers or ratings defined by a Multipurpose Internet Mail Extensions (MIME)-type in some embodiments. The user profile vector may refer to a schema or ontology that may be accessed via the internet or other connection. Thereby, the service providers 35 may access the user profile vector and base the recommendation of content segments at least in part on the user profile vector. In order to provide the service providers 35 with access to the user profile vector, the above-described GET request for content may include the following: an ontology reference URL (or schema) that includes access information indicating how to access the user profile vector, a MIME type for the user profile vector (a representation of data within the user profile vector), an optional item list including item tokens for each corresponding user rating, and/or a user rating vector (user profile vector).

In another embodiment the service providers 35 may embody or be associated with the content module 78 such that a collaborative model may be employed for the user profile. In this regard, the content module 78 may be configured to consult a user profile corresponding to the user account of the user terminal 10 requesting content. Thereby, the content module 78 of the service provider 35 may recommend content based on the user profile. Guest accounts may not function in some embodiments employing this scenario.

In embodiments in which guest login is allowed, a token approach may be employed. In this regard, the content module 78 of the user terminal 10 may append a user profile (e.g., in an XML wrapper) and access information (e.g. a URL) for user profile information to the GET request for content. User terminal credentials may be appended to the GET request in a recommendation section within an XML payload in some embodiments.

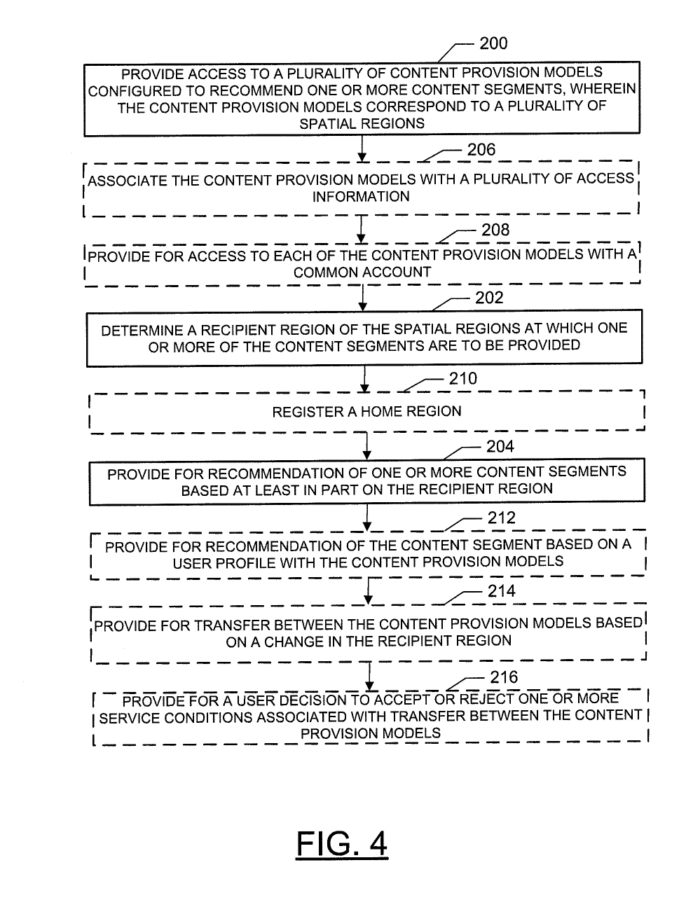

In terms of methods associated with embodiments of the present invention, the above-described apparatus 50 or other embodiments of apparatuses may be employed. In this regard, FIG. 4 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method may include providing access to a plurality of content provision models configured to recommend one or more content segments, wherein the content provision models correspond to a plurality of mutually exclusive spatial regions at operation 200. Further, the method may include determining a recipient region of the mutually exclusive spatial regions at which one or more of the content segments are to be provided at operation 202. Additionally, the method may include providing for recommendation of one or more of the content segments based at least in part on the recipient region at operation 204.

In some embodiments, certain ones of the above-described operations (as illustrated in solid lines in FIG. 4) may be modified or further amplified. In some embodiments additional operations may also be included (some examples of which are shown in dashed lines in FIG. 4). It should be appreciated that each of the modifications, optional additions or amplifications may be included with the above-described operations (200-204) either alone or in combination with any others among the features described herein. As such, each of the other operations as will be described herein may be combinable with the above-described operations (200-204) either alone or with one, more than one, or all of the additional operations in any combination.

For example, the method may further include associating the content provision models with a plurality of access information at operation 206. Also, the method may include providing for access to each of the content provision models with a common account at operation 208. The method may additionally include registering a home region at operation 210. Further, the method may include providing for recommendation of the content segment based on a user profile with the content provision models at operation 212. The method may also include providing for transfer between the content provision models based on a change in the recipient region at operation 214. Additionally, the method may include providing for a user decision to accept or reject one or more service conditions associated with transfer between the content provision models at operation 216.

In an example embodiment, an apparatus for performing the method of FIG. 4 and other methods described above may comprise a processor (for example, the processor 70) configured to perform some or each of the operations (200-216) described above. The processor may, for example, be configured to perform the operations (200-216) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-216 may comprise, for example, the processor 70, the user interface 72, the communication interface 74, the content module 78, the registrar 80, and the locator module 82, as described above. However, the above-described portions of the apparatus 50 as they relate to the operations of the method illustrated in FIG. 4 are merely examples, and it should be understood that various other embodiments may be possible.

In some embodiments the operation 200 of providing access to a plurality of content provision models configured to recommend one or more content segments, wherein the content provision models correspond to a plurality of mutually exclusive spatial regions may be conducted by means, such as the registrar 80, the communication interface 74, and/or the processor 70. Additionally, the operation 202 of determining a recipient region of the mutually exclusive spatial regions at which one or more of the content segments are to be provided may be conducted by means, such as the locator module 82, and/or the processor 70. Also, the operation 204 of providing for recommendation of one or more of the content segments based at least in part on the recipient region may be conducted by means, such as the content module 78, and/or the processor 70.

Further, associating the content provision models with a plurality of access information at operation 206 may be conducted by means, such as the registrar 80, and/or the processor 70. Additionally, the operation 208 of providing for access to each of the content provision models with a common account may be conducted by means, such as the registrar 80, and/or the processor 70. Additionally, the operation 210 of registering a home region may be conducted by means, such as the registrar 80, the locator module 82, and/or the processor 70. Also, the operation 212 of providing for recommendation of the content segment based on a user profile with the content provision models may be conducted by means, such as the content module 78, registrar 80, and/or the processor 70. Further, the operation 214 of providing for transfer between the content provision models based on a change in the recipient region may be conducted by means, such as the locator module 82, registrar 80, content module 78, and/or the processor 70. Additionally, the operation 216 of providing for a user decision to accept or reject one or more service conditions associated with transfer between the content provision models may be conducted by means, such as the registrar 80, and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the processor, cause the apparatus to:
provide access to a plurality of content provision models configured to recommend one or more content segments, wherein the content provision models correspond to a plurality of mutually-exclusive spatial regions;
determine a recipient region of the spatial regions at which one or more of the content segments are to be provided; and
provide for recommendation of one or more of the content segments based at least in part on the recipient region.

2. The apparatus of claim 1, further configured to provide for transfer between the content provision models based on a change in the recipient region.

3. The apparatus of claim 2, further configured to provide for a user decision to accept or reject one or more service conditions associated with transfer between the content provision models.

4. The apparatus of claim 1, further configured to register a home region.

5. The apparatus of claim 1, further configured to associate the content provision models with a plurality of access information.

6. The apparatus of claim 1, wherein the content provision models are further configured to provide for recommendation of the content segment based on a user profile.

7. The apparatus of claim 1, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

8. A method, comprising:
providing access to a plurality of content provision models configured to recommend one or more content segments, wherein the content provision models correspond to a plurality of mutually-exclusive spatial regions;
determining a recipient region via a processor of the spatial regions at which one or more of the content segments are to be provided; and
providing for recommendation of one or more of the content segments based at least in part on the recipient region.

9. The method of claim 8, further comprising providing for transfer between the content provision models based on a change in the recipient region.

10. The method of claim 9, further comprising providing for a user decision to accept or reject one or more service conditions associated with transfer between the content provision models.

11. The method of claim 8, further comprising registering a home region.

12. The method of claim 8, further comprising associating the content provision models with a plurality of access information.

13. The method of claim 8, further comprising providing for recommendation of the content segment based on a user profile with the content provision models.

14. The method of claim 8, further comprising providing for access to each of the content provision models with a common account.

15. A computer program product comprising at least one non-transitory computer-readable storage medium having computer-executable program code portions stored therein, the computer-executable program code portions comprising:
program code instructions providing for access to a plurality of content provision models configured to recommend one or more content segments, wherein the content provision models correspond to a plurality of mutually-exclusive spatial regions;
program code instructions for determining a recipient region of the spatial regions at which one or more of the content segments are to be provided; and
program code instructions providing for recommendation of one or more of the content segments based at least in part on the recipient region.

16. The computer program product of claim 15, further comprising program code instructions providing for transfer between the content provision models based on a change in the recipient region.

17. The computer program product of claim 16, further comprising program code instructions providing for a user decision to accept or reject one or more service conditions associated with transfer between the content provision models.

18. The computer program product of claim 15, further comprising program code instructions for registering a home region.

19. The computer program product of claim 15, further comprising program code instructions for associating the content provision models with a plurality of access information.

20. The computer program product of claim 15, further comprising program code instructions providing for recommendation of the content segment based on a user profile with the content provision models.
